(19) United States
(12) Patent Application Publication
(10) Pub. No.: US 2009/0044880 A1
(43) Pub. Date: Feb. 19, 2009

(54) LOG CUTTING

(76) Inventor: Jody Jones, Eugene, OR (US)

Correspondence Address: PATENTTM.US, P. O. BOX 82788, PORTLAND, OR, 97282-0788, US

(21) Appl. No.: 12/139,755

(22) Filed: Jun. 16, 2008

Related U.S. Application Data
(60) Provisional application No. 60/944,497, filed on Jun. 16, 2007.

(51) Int. Cl. B27L 7/00; B27M 1/00

(52) U.S. Cl. 144/366; 144/194; 144/2.1; 144/49

(57) ABSTRACT

Log cutting is accomplished by energized cutting wires. The wires are energized at ultrasonic frequencies, provided in adjustable grid patterns to produce cut boards of desired sizes by passing a log through the energized grid. Grippers hold the log at each end and move the individual cut boards to storage, banding or drying stations.

### CROSS-REFERENCE TO RELATED APPLICATIONS

This application claims priority from U.S. provisional patent application 60944497 filed Jun. 16, 2007.

### BACKGROUND OF THE INVENTION

This invention relates to cutting of wood, for example, logs.

Cutting of logs into usable dimensional lumber typically involves sawing with rotary saw blades.

### SUMMARY OF THE INVENTION

In accordance with the invention, thin wire-like cutting members are employed, energized or vibrated so as to cut through logs to provide dimensional lumber or desired cut configurations.

Accordingly, it is an object of the present invention to provide an improved log cutting method and apparatus.

It is a further object of the present invention to provide an improved log cutting system employing ultrasonic cutting.

It is yet another object of the present invention to provide an improved wood cutting system employing thin energized cutting members.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of a log being cut in accordance with the invention;

FIG. 2 is a second perspective view of a log being cut in accordance with the invention, with different cutting sizes set; and

FIG. 3 is an end sectional view of a log being cut in accordance with the invention.

### DETAILED DESCRIPTION

The system according to a preferred embodiment of the present invention comprises adjustable cutting wires that are energized or vibrated to cut through logs and provide desired size boards or cants.

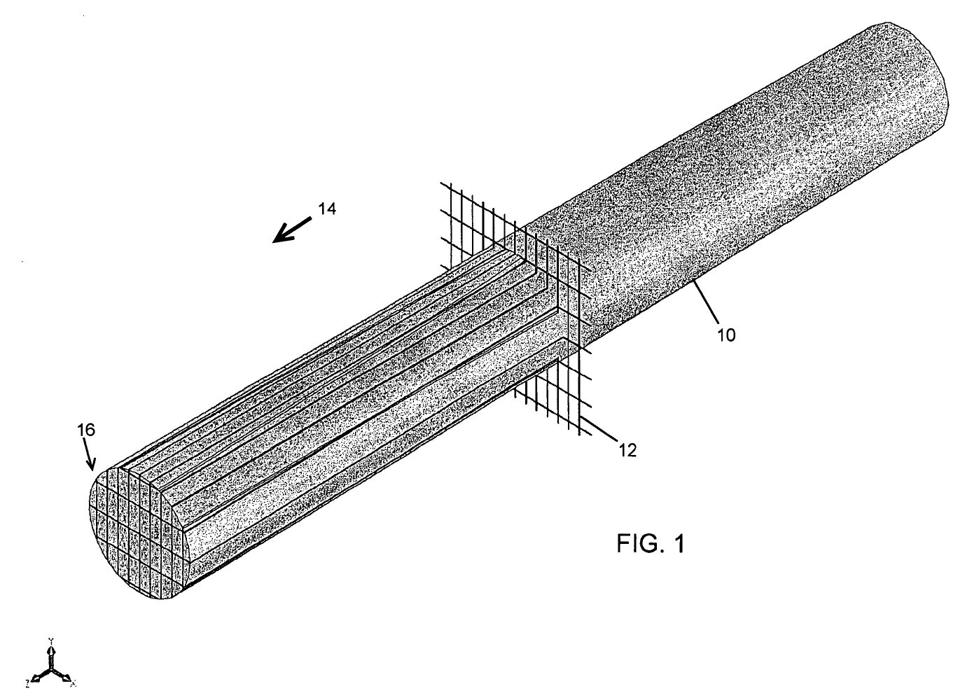

Referring to FIG. 1, a perspective view of a log being cut in accordance with the invention, a log 10 is passed through a cutting grid 12 in the direction of arrow 14 (or the grid is moved through the log) to produce cut dimensional boards as may be observed at the cut end 16 of the log.

The cutting grid 12 comprises a grid of energized or vibrated wires, the wires suitably being very thin, e.g., 0.065 inch or smaller. The wires are energized or vibrated to a high degree, suitably at ultrasonic frequencies, and thereby cut through the log as the log is moved through the grid. The grid provides linear accuracy to the cuts to generate cut boards or cants of desired dimension.

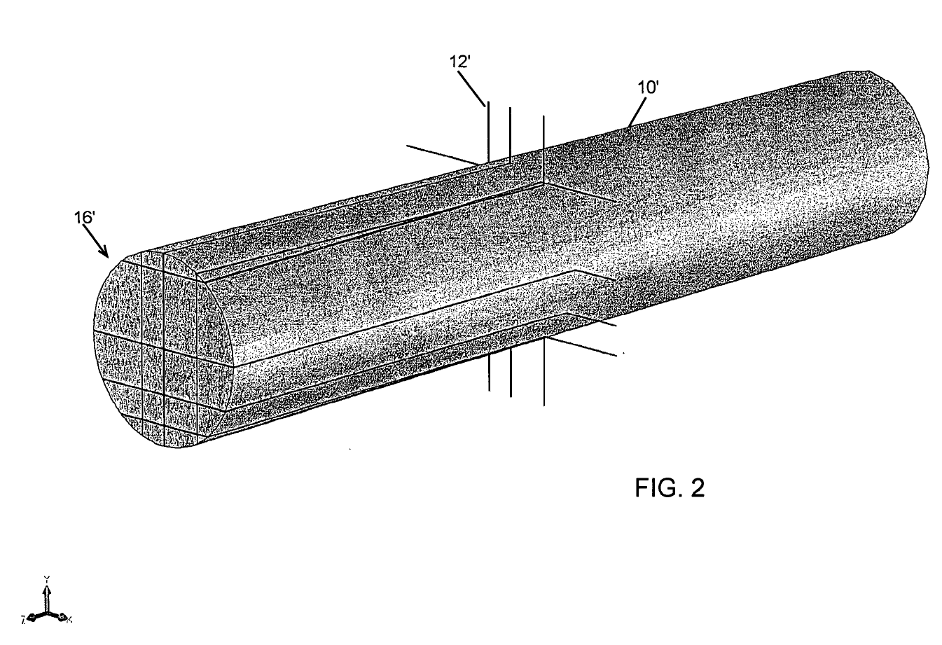

The configuration of FIG. 1 shows a grid pattern having regular spacing. FIG. 2, a second perspective view of a log being cut in accordance with the invention, with different cutting sizes set illustrates a different grid spacing and configuration pattern, whereby different dimension boards are produced as visible at cut end 16′.

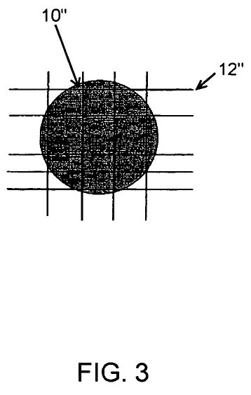

FIG. 3 illustrates an end sectional view showing another grid configuration 12″ cutting through a log 10″ to produce different board sizes.

The grids 12 may also be adjustable to provide variable spacing and cutting configuration variations from log to log or during cutting of an individual log, wherein each (or some) wires are movable independently horizontally or vertically (x and y planes in the views of FIG. 1 and FIG. 2) so as to adjust the size of the cuts. This way, a desired cutting pattern may be employed for any individual log or groups of logs. An individual log may be analyzed in advance of cutting and the grid cutting pattern is adjusted to cut the size boards or cants from that log as desired to provide the proper size boards. Such choice of size can be based on board configurations that are desired, yield optimization (whether wood use or value of produced lumber based).

In operation, each log is held by end grippers or fingers that continue to hold each board independently as the log is passing through the cutting grid and creating the cut boards. The fingers can carry the boards to other cutting grids or individual cutting wires to be trimmed, cut to other sizes or edged.

Suitably, the individual boards remain gripped by the fingers until the board is stacked in an individual unit, banded for inventory/shipment or stacked for drying. Human handling is not required during the process.

In accordance with the invention, logs from 4 to 20 inches diameter, for example, are cut to precise linear dimensions, suitably at speeds of 300 feet per minute or more. The adjustable cutting grid enables a variety of board sizes to be cut and for cuts to be customized to the configuration of individual logs.

The invention provides advantage in that the logs can be broken down by passing once through the cutting grid as contrasted with conventional cutting systems that require multiple passes. The system is also able to break logs down into desired finish lumber product sizes, whereas conventional systems typically require resawing of larger size cut logs portions into finish product sizes.

While ultrasonic vibration is desired as the excitation, lower frequency vibration is also possible.

The desired wire size for the cutting grid is suitably under 0.065 inches. Also, while the illustrated embodiments employ a grid configuration of cutting wires, such cutting wires may be used singularly. Other band-like cutting member configurations maybe be employed in place of or in conjunction with wire cutting member.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A log cutting system, comprising:
an energized cutting member;
a system for moving a log through the energized cutting member.

2. The log cutting system according to claim 1, wherein said energized cutting member comprises a grid of plural cutting members for cutting the log to desired board sizes.

3. The log cutting system according to claim 2, wherein ones of plural cutting members are movable relative to others of said cutting members for adjusting the cutting to variable desired board sizes.

4. The log cutting system according to claim 1, wherein said system for moving a log through the energized cutting member comprises a gripper member that grips the log at first and second ends thereof.

5. The log cutting system according to claim 4, wherein said gripper member comprises plural gripper fingers adapted to grip and hold individual ones of cut board sizes.

6. The log cutting system according to claim 5, wherein said plural gripper fingers hold said individual ones of cut boards until release at a further processing location.

7. A method of cutting logs, comprising:
providing at least one energized cutting member;
moving a log through the energized cutting member.

8. The method of cutting logs according to claim 7, further comprising providing plural ones of said at least one cutting member.

9. The method of cutting logs according to claim 8, wherein said plural energized cutting members are provided in a grid configuration for cutting the log to desired board sizes.

10. The method of cutting logs according to claim 8, comprising moving ones of plural cutting members relative to others of said cutting members for adjusting the cutting to variable desired board sizes.

11. The method of cutting logs according to claim 7, wherein said step of moving a log through the energized cutting member comprises gripping the log at first and second ends thereof.

12. The method of cutting logs according to claim 11, wherein said gripping is accomplished by use of plural gripper fingers adapted to grip and hold individual ones of cut board sizes.

13. The method of cutting logs according to claim 12, wherein said plural gripper fingers hold said individual ones of cut boards until release at a further processing location.

14. A system for cutting logs into boards, comprising:
plural energized cutting members for cutting through a log passing thereby;
a conveyance system for moving the log by the cutting members,
wherein ones of said plural cutting members are movable relative to others of said plural cutting members to define a cutting pattern size so as to cut the log to desired size boards.

15. The system according to claim 14, wherein said conveyance system for moving a log by the energized cutting members comprises a gripper member that grips the log at first and second ends thereof.

16. The system according to claim 15, wherein said gripper member comprises plural gripper fingers adapted to grip and hold individual ones of cut board sizes.

17. The system according to claim 16, wherein said plural gripper fingers hold said individual ones of cut boards until release at a further processing location.

18. The system according to claim 14, wherein ones of said plural cutting members comprise wires.

19. The system according to claim 18, wherein ones of said wires are under 0.065 inch diameter.

20. The system according to claim 14, wherein ones of said plural cutting members are energized by vibration.

21. The system for according to claim 20, wherein said vibration is at ultrasonic frequency.
